(19) United States
(12) Patent Application Publication
(10) Pub. No.: US 2006/0066445 A1
(43) Pub. Date: Mar. 30, 2006

(54) Emergency contact apparatus and method for mobile communication

(76) Inventor: Tzu-Hsuan Lo, Taoyuan (TW)

Correspondence Address: HOFFMAN WARNICK & D'ALESSANDRO, LLC, 75 STATE STREET, 14TH FL, ALBANY, NY, 12207, US

(21) Appl. No.: 11/236,963

(22) Filed: Sep. 28, 2005

(30) Foreign Application Priority Data
Sep. 29, 2004 (TW) 093129490

(51) Int. Cl. G09F 25/00

(52) U.S. Cl. 340/286.01

(57) ABSTRACT

This invention provides an emergency contact apparatus used in mobile communication. The emergency contact apparatus includes a memory device, a triggering device, a position responding device, and a transmitting device. The memory device is used for storing contact group information and an emergency message. The triggering device is used for generating a trigger signal. The position responding device is used for receiving the trigger signal and generating current position information. The transmitting device is connected to the memory device, the triggering device, and the position responding device. The transmitting device is used for receiving the trigger signal and transmitting the emergency message and the position information based on the contact group information.

### BACKGROUND OF THE INVENTION

1. Field of the Invention

This present invention relates to an emergency contact apparatus. More particularly, the invention relates to an emergency contact apparatus used in a mobile communication environment.

2. Description of the Prior Art

The common emergency number such as 911 can be dialed directly by a general telephone. Beside, the emergency contact system can also be activated by mobile phones. For example, the mobile phone users could dial a service number (for example 112) to contact the service center, and the service center then transfers the phone call through an automatic computer speech system to an emergency line like 911; hence, users can contact the appropriate emergency service centers. The emergency contact system described above is just a transferring procedure. The phone call dialed by the mobile phone, through any telecommunication systems that can receive the signal, is transferred to 911 through the service center to contact with the emergency service center. However, when a user suffers from an injury and cannot dial or speak, it is very difficult for the injured user to contact with the emergency service center by employing a general telephone or mobile phone because the incapacity of the injured user.

When employing the general telephone or the mobile phone to contact with the emergency service center, the user needs to dial the number first and tell the emergency service center the emergency condition. If the user is handicapped or is threatened by a criminal, thus losing self-mobility, the user cannot dial the number to contact the emergency service center and report about the emergency condition.

Therefore, the main objective of the present invention is to provide an emergency contact apparatus and method for mobile communication to solve the problems described above.

### SUMMARY OF THE INVENTION

The main objective of the present invention is to provide an emergency contact apparatus and method. When the user is handicapped or loses self-mobility, the emergency contact apparatus and method can provide the function of emergency contact in a more convenient manner.

Another objective of the present invention is to provide an emergency contact apparatus and method, so a user can easily and simply press a triggering button or like device when in danger or emergency situation, and the emergency message asking for help will be sent out to serve for the purpose of emergency contact.

The present invention provides an emergency contact apparatus used in mobile communication. The emergency contact apparatus includes a memory device, a triggering device, a position responding device, and a transmitting device. The memory device is used for storing data or information associated with a pre-defined contact group and an emergency message. The triggering device is used for generating a trigger signal. The position responding device is used for generating position information after receiving the trigger signal. The transmitting device is electrically connected to the memory device, the triggering device, and the position responding device. Upon receiving the trigger signal, and the transmitting device would then transmit the emergency message and the position information according to the data or information in the pre-defined contact group.

The present invention also provides an emergency contact method in mobile communication. The emergency contact method employs a personal communication apparatus to transmit an emergency message to a pre-defined or predetermined contact apparatus. The emergency contact method first employs the personal communication apparatus to generate a trigger signal. Afterwards, the personal communication apparatus generates position information in responsive to the trigger signal, and it then transmits the emergency message and the position information via wireless transmission or in a wireless manner to the predetermined contact apparatus according to data or information in a pre-defined contact group.

The emergency contact apparatus used in mobile communication according to the present invention employs the triggering device to activate emergency contact. The emergency contact apparatus can transmit the predetermined stored emergency message and the information of the current position of the user to the contact group information by operating the triggering device in a simple way, thus providing the user a convenient manner for emergency contact purpose. Because the operation of the emergency contact apparatus of the invention is simple, the user does not even have to dial the number but can just operate the emergency contact apparatus simply for emergency contact.

The advantage and spirit of the invention may be understood by the following recitations together with the appended drawings.

### BRIEF DESCRIPTION OF THE APPENDED DRAWINGS

FIG. 1 is a block diagram illustrating an emergency contact apparatus according to the present invention.

FIG. 2 is a flowchart illustrating the steps of an emergency contact method according to the present invention.

FIG. 3 is a flowchart illustrating the steps of a method for remotely recording sound according to the present invention.

### DETAILED DESCRIPTION OF THE INVENTION

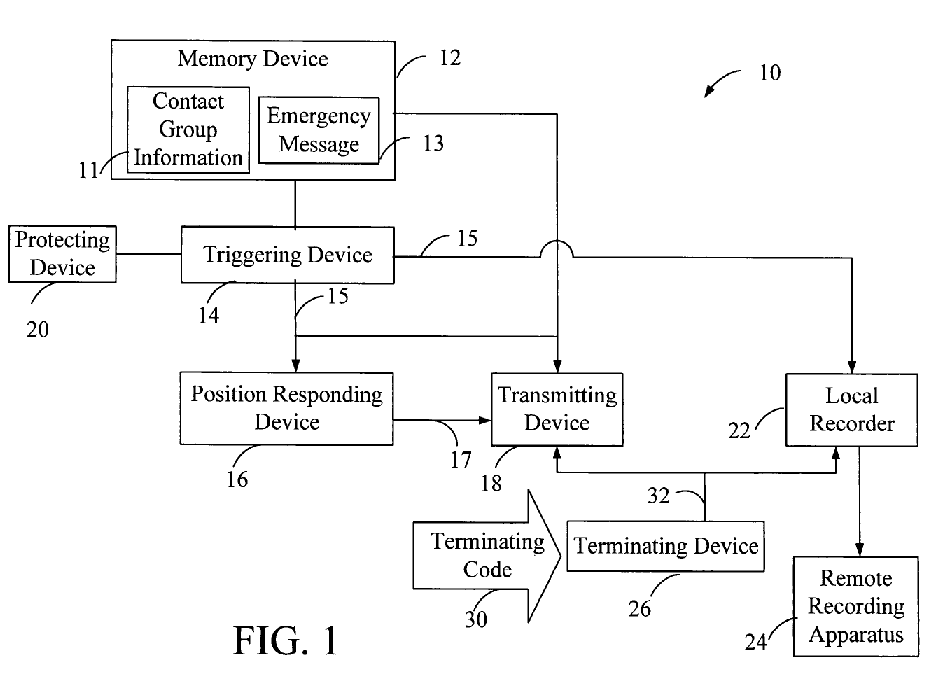

Referring to FIG. 1, FIG. 1 is a block diagram illustrating an emergency contact apparatus 10 according to an embodiment of the present invention. In this embodiment, the emergency contact apparatus 10 is used in a mobile communication environment. The emergency contact apparatus 10 includes a memory device 12, a triggering device 14, a position responding device 16, and a transmitting device 18.

The memory device 12 is used for storing a set of pre-defined or predetermined contact data or information (contact group information) 11 and an emergency message 13. In an embodiment, the memory device 12 is a Subscriber Identity Model (SIM) card. The triggering device 14 is used for generating a trigger signal 15. The position responding device 16 is used for generating position information 17 in responsive to the trigger signal 15. The position information 17 includes a location area identity (location area ID) and a serving cell identity (serving cell ID) assigned in the mobile communication. The transmitting device 18 is electrically connected to the memory device 12, the triggering device 14, and the position responding device 16. In responsive to or upon receiving the trigger signal 15, the transmitting device 18 would then transmit the emergency message 13 and the position information 17 according to the pre-defined or predetermined contact data or information 11 in the memory device 12.

Because the serving cell IDs at different locations might be coded with a same number, the emergency contact apparatus of the invention employs the location area ID that covers a larger area to find out which area the user is located in, and then it employs the serving cell ID to find out the refined or more exacting location of the user. Thereby, the emergency contact apparatus can accurately find out the current location of the user.

In the embodiment of the present invention shown in FIG. 1, the emergency contact apparatus 10 further includes a local recorder 22 connected to the triggering device 14. Upon receiving the trigger signal 15 from the triggering device 14, the local recorder 22 would then retrieve or record the sound or voice taken around the environment of the emergency contact apparatus and generate a corresponding first voice message to the transmitting device 18. The transmitting device 18 then transmits the first voice message based on the set of contact data or information 11 in the memory device 12.

In another embodiment of the present invention shown in FIG. 1, the emergency contact apparatus 10 further includes a remote recorder or a remote recording apparatus 24. After receiving the trigger signal 15, the local recorder 22 generates a recording triggering signal to trigger the remote recording apparatus 24. After receiving the recording triggering signal via the wireless transmission, the remote recording apparatus 24 then record the accompanying received first voice message and store it. In this embodiment, the emergency message 13, the position information 17, and the first voice message are transmitted together by the transmitting device 18.

When the remote recording apparatus 24 is on the process of storing the first voice message, the transmitting device 18 may at the same time generate a second voice message. Upon the generation of the second voice message, the local recorder 22 would stop generating the first voice message, i.e. stop recording the sound or voice around the environment of the emergency contact apparatus 10. When the transmitting device 18 finishes with the generation and transmission of the second voice message, the transmitting device 18 further generates a reset message to the local recorder 22 so that the generation of the first voice message can be resumed after the receipt of the reset message by the local recorder 22.

The emergency contact apparatus 10 further includes a terminating device 26 connected to the transmitting device 18. After receiving a terminating code 30, the terminating device 26 generates a terminating signal 32 to the local recorder 22 to stop generating the first voice message. The transmitting device 18 then stops transmitting the emergency message 13 and the position information 17 after it receives the terminating signal 32 sent by the terminating device 26.

The emergency contact apparatus 10 further includes a protecting device 20 connected to the triggering device 14. If the triggering device 14 is in the form of a single triggering button, then the protecting device 20 can be a cover on the button to prevent an unintended generation of the trigger signal when the user touches the button by mistake. In fact, the protecting device 20 can be software-implemented just as many protecting mechanism implemented by software in the mobile phone nowadays. For example, the trigger signal would not be generated unless the triggering button is being pressed for longer than 3 seconds. In sum, the protecting device 20 can be any hardware, or software or hardware/software combined means to prevent from user's unintentional pressing of the triggering device 14 to generate the trigger signal 15.

In one embodiment, the emergency contact apparatus 10 of the present invention can be applied in the mobile phone. The memory device 12 can be the subscriber identity model (SIM) card of the mobile phone, and the triggering device 14 is a triggering button of the mobile phone. The contact group information 11 and the emergency message 13 are usually stored in the SIM card in advance by the mobile phone users. In this embodiment, the emergency message 13 can be a short statement, a voice message or a word message previously recorded by the user. Once a user is in danger or suffers injury, all he has to do is to press the triggering button, and the mobile phone will send out the previously stored emergency message 13 and the current position information 17 in accordance with the contact group information 11. In another embodiment, if none of the people who are listed in the contact group information answers the phone, the mobile phone will send a recording triggering signal to the remote recording apparatus 24. The remote recording apparatus 24 will trigger the sound recording function in the emergency contact apparatus 10 and the first voice message is generated by recording the sound or voice around the environment of the emergency contact apparatus 10. The first voice message is then sent by the wireless network and is recorded in remote recording apparatus 24. In this embodiment, the first voice message might reflect the surroundings of the mobile phone, and the remote recording apparatus 24 might be a voice message operation of the mobile communication system to completely tape the conditions or situations of the user.

During the sound recording of the first voice message, if the user wants to send a second voice message, the recording will stop automatically and the second voice message will be sent. In a practical application, sending the second voice message can be dialing the emergency service number (for example 112) to contact the service center. For example, if users could dial an emergency service call during the sound recording of the first voice message, the emergency contact apparatus 10 will stop recording automatically. The emergency contact apparatus 10 will resume the recording function when the emergency service call is terminated. Moreover, the mobile phone employing the emergency contact apparatus 10 of the invention further includes a terminating code 30, which is used for terminating all the functions and/or operations relating to emergency purpose of the emergency contact apparatus 10. When the mobile phone receives the terminating code 30, it will stop sending the emergency message 13 and the position information 17, and the sound recording will be stopped as well.

The contact group information 11 and the emergency message 13 are generally pre-stored in the memory device 12 in the emergency contact apparatus 10. Therefore, the user who suffers injury can simply press the triggering device 15 to send the position information and the emergency message according to the contact group information 11, thus achieving the function of emergency contact. Furthermore, the emergency contact apparatus 10 of the invention also provides the sound recording function for the user to record all the conversation and sounds in the surrounding situation in an automatic manner. By sending out emergency messages or proceeding emergency contact when emergency occurs, the original scene of the emergency situation can be faithfully rebuilt in the future when necessary.

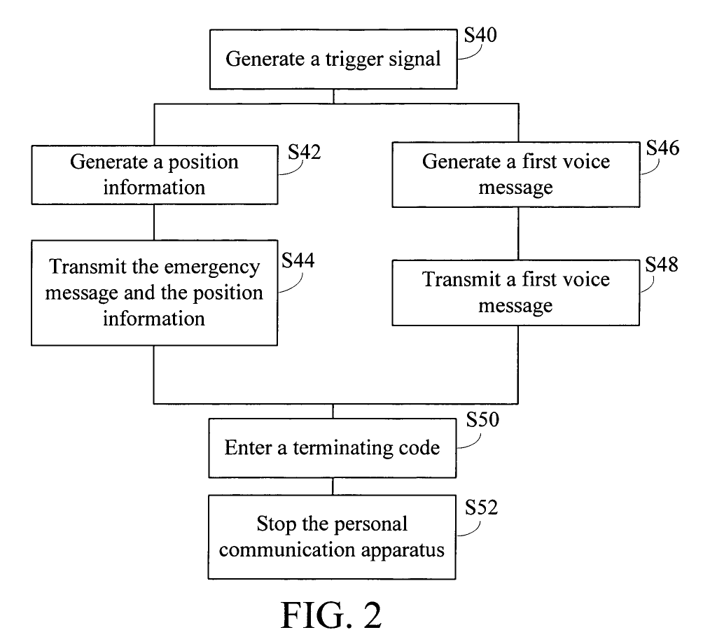

Referring to FIG. 2, FIG. 2 is a flowchart illustrating an emergency contact method according to the present invention. The invention also provides an emergency contact method used in mobile communication for employing a personal communication apparatus to transmit an emergency message to a predetermined contact apparatus. The emergency contact method includes the following steps. First, step S40 is performed to generate a trigger signal by the personal communication apparatus. Afterwards, step S42 is performed. In step S42, the personal communication apparatus generates position information which includes a location area ID and a serving cell ID assigned in the mobile communication after receiving the trigger signal. Step S44 is then performed. In step S44, the emergency message and the position information are transmitted by the personal communication apparatus to the predetermined contact apparatus via wireless transmission according to contact group information. The contact group information and the emergency message are stored in a subscriber identity module (SIM) card.

When the personal communication apparatus is performing step S42 and S44 to generate the position information in response to the trigger signal, the emergency contact method of the invention also at the same time performs step S46 and step S48. In step S46, the personal communication apparatus generates a first voice message according to the trigger signal. Step S48 is then performed. In step S48, the personal communication apparatus transmits the first voice message to the predetermined contact apparatus via the wireless transmission.

The personal communication apparatus transmits the above-mentioned emergency message and the position information, as well as the first voice message. In the emergency contact apparatus of the present invention, the personal communication apparatus can be used to generate a second voice message while the first voice message is being stored. The personal communication apparatus stops transmitting the first voice message when the second voice message is in process. The personal communication apparatus will re-generate the first voice message to a remote recording apparatus after the transmission of the second voice message is terminated.

After the emergency message, the position information, and the first voice message are transmitted, the user can stop the emergency contact by performing the following steps. First, step S50 is performed to enter a terminating code into the personal communication apparatus. Step S52 is then performed. In step S52, after receiving the terminating code, the personal communication apparatus stops generating the first voice message to the remote recording apparatus, and it also stops transmitting the emergency message and the position information to the predetermined contact apparatus.

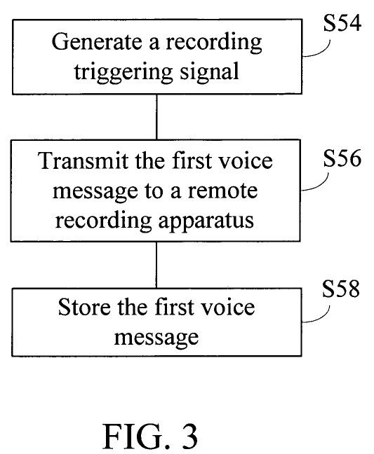

Referring to FIG. 3, FIG. 3 is a flowchart illustrating a method for remote sound recording according to the present invention. When the emergency contact apparatus of the invention is unable to contact the predetermined contact apparatus while sending the first voice message, the emergency contact method of the invention further includes the following steps. In step S54, the personal communication apparatus generates a recording triggering signal according to the trigger signal. Step S56 is then performed. In step S56, the personal communication apparatus transmits the first voice message to a remote recording apparatus. Finally, step S58 is performed. In step S58, the remote recording apparatus stores the first voice message after receiving the recording triggering signal.

The emergency contact apparatus of the invention employs a button as the triggering device. When the button is pressed, the emergency contact apparatus will automatically send the pre-stored emergency message and the current position information of the user based on the predefined contact group information. The emergency contact apparatus of the invention also provides the sound recording function for the user to record the sounds of the surrounding environment he is situated. Therefore, the emergency contact apparatus of the invention not only provides the user an easy way for emergency contact, but also records the sounds of the entire situation of the user to help faithfully rebuild the scene in the future when necessary.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An emergency contact apparatus used in a mobile communication, said emergency contact apparatus comprising:
a memory device for storing data associated with a pre-defined contact group and an emergency message;
a triggering device for generating a trigger signal once operated by a user;
a position responding device, electrically connected to the triggering device, for generating position information in response to the trigger signal; and
a transmitting device, electrically connected to the memory device, the triggering device and the position responding device respectively, for transmitting, responsive to the trigger signal, the emergency message and the position information in accordance with the data associated with the pre-defined contact group.

2. The emergency contact apparatus of claim 1, wherein the position information comprises a location area identity and a serving cell identity assigned in the mobile communication.

3. The emergency contact apparatus of claim 1, wherein the memory device is a Subscriber Identity Module (SIM) card.

4. The emergency contact apparatus of claim 1, wherein the triggering device is a button.

5. The emergency contact apparatus of claim 1, further comprising a protecting device connected to the triggering device to prevent an unintended generation of the trigger signal when the user touches the triggering device by mistake.

6. The emergency contact apparatus of claim 1, further comprising a local recorder, electrically connected to the triggering device and the transmitting device respectively, for retrieving, responsive to the trigger signal, a first voice message, and sending the first voice message to the transmitting device, wherein the transmitting device also transmits, responsive to the trigger signal, the first voice message in accordance with the data associated with the pre-defined contact group.

7. The emergency contact apparatus of claim 6, wherein the first voice message comprising sound recording taken around said emergency contact apparatus.

8. The emergency contact apparatus of claim 7, wherein the transmitting device transmits the emergency message and the position information together with the first voice message.

9. The emergency contact apparatus of claim 6, wherein the transmitting device further generates a second voice message, and wherein the first voice message is ceased when the second voice message is generated.

10. The emergency contact apparatus of claim 9, wherein after the second voice message is terminated, the transmitting device further generates a reset message to a local recorder to generate the first voice message again.

11. The emergency contact apparatus of claim 6, further comprising a terminating device to stop generating the first voice message.

12. The emergency contact apparatus of claim 11, wherein the terminating device is further connected to the transmitting device, the transmitting device stopping transmitting the emergency message and the position information after receiving a terminating signal sent by the terminating device.

13. An emergency contact method used in mobile communication for employing a personal communication apparatus to transmit an emergency message to at least a predetermined contact apparatus, the emergency contact method comprising the following steps:
(a) generating a trigger signal by the personal communication apparatus;
(b) generating a position information of the personal communication apparatus after receiving the trigger signal; and
(c) transmitting the emergency message and the position information to the predetermined contact apparatus in a wireless manner according to information of a pre-defined contact group.

14. The emergency contact method of claim 13, wherein the position information comprises a location area identity and a serving cell identity assigned in the mobile communication.

15. The emergency contact method of claim 13, wherein the information of a pre-defined contact group is stored in the personal communication apparatus.

16. The emergency contact method of claim 13, wherein the emergency message is stored in the personal communication apparatus in advance.

17. The emergency contact method of claim 13, wherein the emergency message is a sound recording to the emergency contact apparatus.

18. The emergency contact method of claim 13, wherein the emergency contact method further comprises the following steps:
(d) generating a first voice message by the personal communication apparatus according to the trigger signal; and
(e) transmitting the first voice message by the personal communication apparatus to the predetermined contact apparatus.

19. The emergency contact method of claim 18, wherein the emergency contact method further comprises the following steps:
(f) generating a recording triggering signal by the personal communication apparatus according to the trigger signal;
(g) transmitting the first voice message by the personal communication apparatus to a remote recording apparatus; and
(h) storing the first voice message in the remote recording apparatus.

20. The emergency contact method of claim 18, wherein the emergency contact method further comprises the following steps:
(i) generating a second voice message by the personal communication apparatus, and when the personal communication apparatus starts generating the second voice message, the personal communication apparatus stopping generating the first voice message; and
(j) re-generating the first voice message to the predetermined contact apparatus by the personal communication apparatus after the transmission of the second voice message is terminated.
